(19) United States
(12) Patent Application Publication
(10) Pub. No.: US 2004/0110500 A1
(43) Pub. Date: Jun. 10, 2004

(54) Method and system for controlling connection establishment

(76) Inventors: Marko Koskela, Oulu (FI); Juhani Latvakoski, Haukipudas (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/470,019

(22) PCT Filed: Jan. 23, 2002
(86) PCT No.: PCT/EP02/00661

(30) Foreign Application Priority Data
Jan. 23, 2001 (DE) 101 02 983.7

(51) Int. Cl. H04B 7/00; H04Q 7/20

(52) U.S. Cl. 455/422.1; 455/515; 455/67.11

(57) ABSTRACT

A method and system for controlling connection establishment in a network architecture comprising at least two systems or domains through which said call establishment can be initialized, wherein a control information is provided in a terminal device, and a changing function is provided for changing the control information. The control information is used for selecting one of said at least two systems or domains, to be used for initializing said call establishment. Thus, a mobile originated call establishment can be initiated in a controlled manner through a desired network domain or system.

### FIELD OF THE INVENTION

The invention relates to a controlling mechanism for mobile originated call routing, to be applied to guide the terminal/user in mobile originated connection establishments, e.g. call or session establishments, so that the terminal knows in which one of at least two systems or domains the new established call should be initiated, e.g. circuit switched (CS) domain or packet switched (PS)/IP Multimedia (IM) domain in case of voice over IP calls (VolP calls) to public switched telephone network (PSTN)/integrated services digital network (ISDN). Therefore, a new control information is defined, and the ways of initializing, storing and changing it.

### BACKGROUND OF THE INVENTION

In known communication or data networks, some of the network operators may want to support IM subsystems only, and provide services with it without any CS domain, only using mobile switching centres (MSCs). Other network operators may want to route all voice calls through the CS domain, even if an IM subsystem is applied.

FIG. 1 shows as an example of a network architecture comprising a core network (CN) 6 with a CS domain 7 and a PS domain 13. The CN 6 is connected to a radio network 5 to provide mobile access, e.g. via mobile terminals 41, 42. Further, a service network 8 with a streamer server 9 is linked via the PS domain 13 to the mobile terminal 42. There is shown a first ISDN user part (ISUP) interface between the CS domain 7 and a PSTN/ISDN 2. A second interface is provided between an IM subsystem 1, e.g. an IM CN, and the PSTN/ISDN 2. The IM CN 1 also provides a gateway to the Internet 10 and terminals 11, 12.

In the case of the second interface, it is currently not known whether the ISUP interface between the IM CN 1 and a PSTN/ISDN Gateway 3 will be specified in the 3^{rd} Generation Partnership Project (3GPP) standardization or not. Independently from this 3GPP decision, there still exists the problem, that mobile terminals 41, 42 must know how the operator wants to route mobile originated calls and other services. For example, should the terminals/users route all voice calls through the IM CN 1 and a PS domain 13, or should they route them through a CS domain 7 (such as normal CS calls as today in GSM systems).

In addition, users may want to use either the CS domain 7 or the PS domain 13 only, or they may have a certain preference order for the use of domains or systems, because of cost issues for example. Also the operators might have subscriber specific reasons to route all their initiated calls through specific domains or systems. The systems may comprise any access system or subsystem through which a call or session can be established.

However, such subscriber specific or operator selection processes are currently not supported by any available standards.

### SUMMARY OF THE INVENTION

It is therefore an object of the present invention to provide a call control method and system by means of which the terminal is informed of the domain or system available for a call establishment.

This object is achieved by a method for controlling connection establishment in a network architecture comprising at least two systems or domains through which said connection establishment can be initialized, comprising the steps of: providing a control information at a terminal device, providing a changing function for changing said control information, and using said control information for selecting one of said at least two systems or domains, to be used for initializing said connection establishment.

Furthermore, the above object is achieved by a system for controlling connection establishment in a network architecture comprising at least two systems or domains through which said connection establishment can be initialized, said system comprising:

storing means for storing a control information in a terminal device, changing means for changing said control information, and selecting means for selecting one of said at least two systems or domains, to be used for initializing said connection establishment, based on said control information.

The provision of the control information may be performed from the network to the terminal device. The control information may be delivered in a dedicated manner e.g. by using a signalling connection. As an alternative, the control information may be broadcast to all terminal devices accessing the network. Preferably, the control information may be broadcast or delivered to the terminal device by any dedicated means of transferring this information to the terminal device, e.g. at time of registering into the network, during a control information update or even during call establishment signalling.

Furthermore, the control information may be stored in the terminal device.

According to an advantageous further development, the control information may consists of a set of elementary instructions per service type provided to said terminal devices. This set of elementary instructions may comprise instructions for restricting the terminal device to initiate a call through a specific system or domain. Furthermore, the set of elementary instructions may comprise instructions for causing the terminal device to initiate a call through a preferred system or domain.

The control information may be changeable by a user of the terminal device. Accordingly, a new controlling mechanism is provided to be applied to guide the terminal in mobile originated connection establishments so that the terminal knows in which network domain or system the new established call or session should be initiated. The network domains or systems may comprise the CS domain and/or the PS/IM domain, e.g. in case of a VoIP call establishment to PSTN/ISDN. The background motivation for this may also be the operator specific existence of an interface between the IM subsystem and the PSTN/ISDN gateway. The other reason may be need to control the call initiations in overloading situations. For example, a situation when there is an overloading in the CS domain side and available capacity in the PS domain side. Then all new mobile originated established calls should use the PS side because there is more capacity available.

The key in this controlling mechanism is the control information, which can be initialized, changed and stored, depending on the operator and user needs and the agreement between them.

The main advantage of the invention is, that the mobile originated call establishments can be initiated in controlled manner through a desired network domain or system, e.g. through the CS domain or through the PS/IM domain. Moreover, an operator specific network configuration and congestion control is supported. The control mechanism can be subscriber specific or it can control all terminals at the same time, i.e. different subscribers at the same geographical area can behave differently according to the user and operator needs. In addition, also subscriber specific control can be used if the operator allows it. Thus, user needs and/or operator needs are supported in a flexible way.

### BRIEF DESCRIPTION OF THE DRAWINGS

In the following, a preferred embodiment of the invention will be described in greater detail with reference to the accompanying drawings, in which:

FIG. 1 shows a network architecture with different domains and systems, to which the present invention can be applied, and

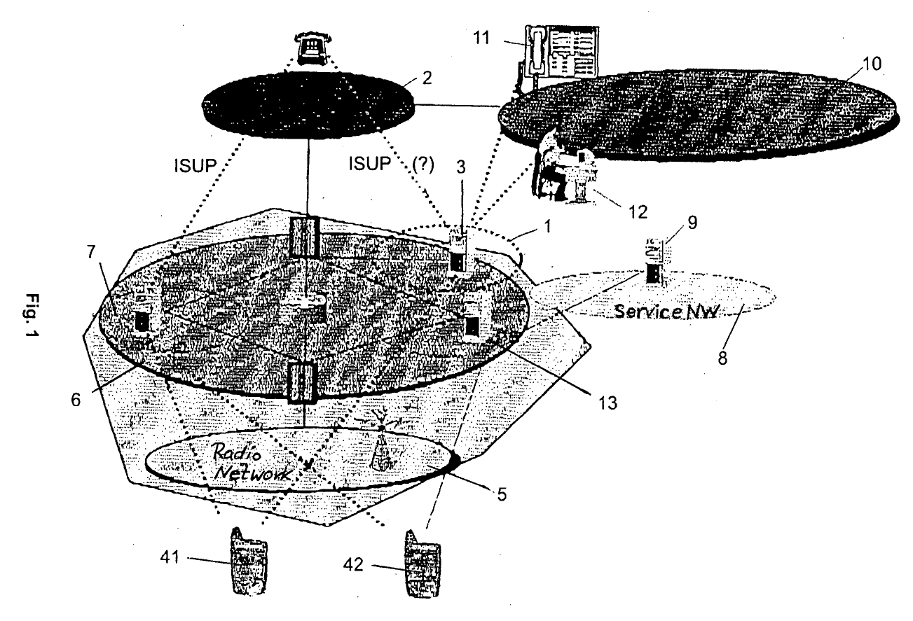

FIG. 2 shows a schematic diagram indicating a control mechanism according to the preferred embodiment.

### DESCRIPTION OF THE PREFERRED EMBODIMENT

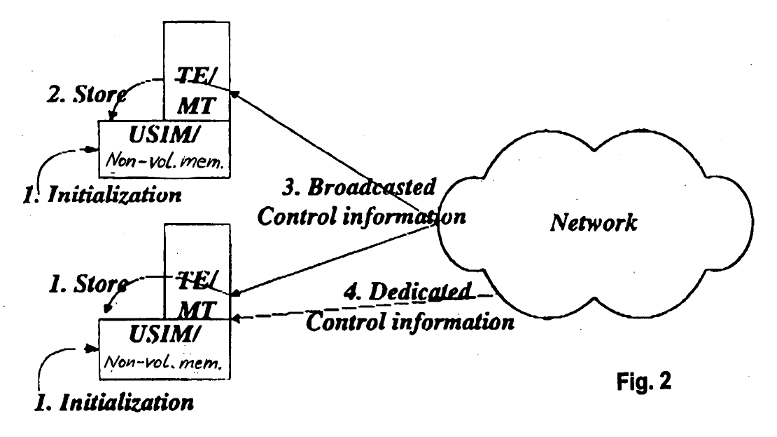

FIG. 2 shows a control mechanism according to the preferred embodiment for establishing a connection in a network architecture comprising different domains and systems. In particular, a control information can be initialized, changed and stored depending on the operator and user needs and an agreement between them.

In a first mechanism 1, the network or system operator can initialize this control information and store it in the universal subscriber identity module (USIM) when the USIM is sold to the customer. Then it can be updated later, e.g. by using a SIM application toolkit (SAT) or other similar solutions. The control information can also be alternatively stored in a non-volatile memory (e.g. EEPROM) or a volatile memory (e.g. RAM) which can be modified by the terminal device.

In any case, in a second mechanism 2 the operator can allow a user to change this control information, and the operator can also change it using mechanisms 3. and/or 4. The changed control information is stored in the USIM or a non-volatile memory, e.g. EEPROM, or a RAM.

In mechanism 3, the operator can broadcast the changes of this control information as a part of a system information message, using e.g. broadcast channels such as CBCH (Cell Broadcast Channel) or BCCH (Boradcast Control Channel), i.e. sysinfos etc. This is quite applicable when controlling the call activations of all terminals.

In mechanism 4, the operator can also provide or deliver this control information to a user terminal in a dedicated manner with a dedicated transferring means, e.g. dedicated channels when terminal registers into the network or during e.g. location update, routing area update, combined update procedure or even during the call establishment procedure.

The control information may consist of a set of instructions per service type—given to the terminal/user. The service type can be defined here alternatively according to quality of service classes or using other service type categories like voice, video stream, multimedia real-time video calls, emergency calls, supplementary services, browsing etc.

The following elementary instructions may be used:

1. PS/IM only: Terminal shall always initiate the calls of the specific service type through PS/IM domains.

2. PS/IM preferred: Terminal shall always initiate the calls of the specific service type through PS/IM domains. However, if call attempt fails for some reason (e.g. congestion at the network) it is allowed for the terminal to establish call through CS domain.

3. CS only: Terminal shall always initiate the calls of the specific service type through CS domains.

4. CS preferred: Terminal shall always initiate the calls of the specific service type through CS domain. However, if call attempt fails for some reason (e.g. congestion at the network) it is allowed for the terminal to establish call through PS/IM domain.

5. Don't care: Operator do not want to set any requirements how terminal initiates call.

As an example, the operator can use these parameters for example for congestion control: First the operator may set the parameters to “Don't care”. When the operator/network notices a congestion, e.g. at the PS domain, it can immediately set this parameter to “CS only”. After that all new call initiations will be initiated to the CS domain.

Finally, it should be noted that the method and the system of the present invention is not restricted to the preferred embodiment described above. The method for controlling the connection establishment, e.g. call establishment or any session establishment, can be applied to any network architecture comprising at least two systems, access systems or subsystems like e.g. domains through which the call establishment can be initialized. By providing the control information at the terminal device, wherein a changing function for changing the control information may be provided, the control information is used for selecting one of said at least two systems or domains for initializing the connection establishment. The preferred embodiment may thus vary within the scope of the attached claims.

1. A method for controlling connection establishment in a network architecture comprising at least two systems or domains through which said call establishment can be initialized, comprising the steps of:
a) providing a control information at a terminal device,
b) providing a changing function for changing said control information, and
c) using said control information for selecting one of said at least two systems or domains, to be used for initializing said call establishment.

2. A method according to claim 1,
wherein said providing of said control information is performed from said network architecture to said terminal device.

3. A method according to claim 2,
wherein said providing step comprises broadcasting said control information to a terminal device accessing said network architecture.

4. A method according to claim 3,
wherein said control information is varied across said network architecture.

5. A method according to claim 2,
wherein said control information is dedicated for said terminal device and is provided at time of registering into the network architecture or connection establishment or other signalling communication between said network architecture and said terminal device.

6. A method according to any one of claims 1 to 5,
wherein said control information is stored in said terminal device.

7. A method according to any one of claims 1 to 6,
wherein a default control information is stored in said terminal device.

8. A method according to any one of claims 1 to 7,
wherein said control information consists of a set of elementary instructions per service type provided to said terminal device.

9. A method according to claim 8,
wherein said set of elementary instructions comprises instructions for restricting said terminal device to initiate a call through a specific system or domain.

10. A method according to claim 8 or 9,
wherein said set of elementary instructions comprises instructions for causing said terminal device to initiate a call through a preferred system or domain.

11. A method of anyone of claims 1 to 10,
wherein said control information is changeable by a user of said terminal device.

12. A method of anyone of claims 1 to 11,
wherein said network domains or systems comprise a CS domain and/or a PS/IM domain

13. A system for controlling call establishment in a network architecture comprising at least two systems or domains through which said call establishment can be initialized, said system comprising:
a) storing means for storing a control information in a terminal device,
b) changing means for changing said control information, and
c) selecting means for selecting one of said at least two systems or domains, to be used for initializing said call establishment, based on said control information.

14. A system according to claim 13,
wherein said system is arranged to provide said control information from said network architecture to said terminal device.

15. A system according to claim 14,
wherein said system is arranged to broadcast said control information to a terminal device accessing said network architecture.

16. A system according to claim 15,
wherein said system is arranged to vary said control information across said network architecture.

17. A system according to claim 14,
wherein said system is arranged to dedicate said control information for said terminal device and to provide it at time of registering into the network architecture or connection establishment or other signalling communication between said network architecture and said terminal device.

18. A system according to any one of claims 13 to 17,
wherein said control information is stored in said terminal device.

19. A system according to any one of claims 13 to 18,
wherein a default control information is stored in said terminal device.

20. A system according to any one of claims 13 to 19,
wherein said control information consists of a set of elementary instructions per service type provided to said terminal device.

21. A system according to claim 20,
wherein said set of elementary instructions comprises instructions for restricting said terminal device to initiate a call through a specific system or domain.

22. A system according to claim 20 or 21,
wherein said set of elementary instructions comprises instructions for causing said terminal device to initiate a call through a preferred system or domain.

23. A system of anyone of claims 13 to 22,
wherein said control information is changeable by a user of said terminal device.

24. A system of anyone of claims 13 to 23,
wherein said network domains or systems comprise a CS domain and/or a PS/IM domain

25. A terminal device for controlling connection establishment in a network architecture comprising at least two systems or domains, through which said call establishment can be initialised, said device comprising:
a) storing means for storing a control information;
b) changing means for changing said control information, and
c) selecting means for selecting one of said at least two systems or domains, to be used for initializing said call establishment, based on said control information.

26. A device according to claim 25, wherein said terminal device is arranged to receive said control information from said network architecture.

27. A device according to claim 25, wherein said changing means are operable by a user of said terminal device, so as to change said control information.

28. A device according to any one of claims 25 to 27,
wherein said terminal device is arranged to store a default control information in said storing means.

29. A device according to any one of claims 25 to 28,
wherein said control information consists of a set of elementary instructions per service type provided to said terminal device.

30. A device according to claim 29,
wherein said set of elementary instructions comprises instructions for restricting said terminal device to initiate a call through a specific system or domain.

31. A device according to claim 29 or 30,
wherein said set of elementary instructions comprises instructions for causing said terminal device to initiate a call through a preferred system or domain.

32. A device according to any one of claims 25 to 31,
wherein said control information is changeable by a user of said terminal device.
